(19) United States
(12) Patent Application Publication
(10) Pub. No.: US 2010/0055633 A1
(43) Pub. Date: Mar. 4, 2010

(54) Crimping Machine, Method for Crimping a Tube on an Archwire Using Same and Method for Joining a Plurality of Archwire Segments Using Same

(76) Inventor: Arthur L. Wool, Wyomissing, PA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/199,134

(22) Filed: Aug. 27, 2008

(51) Int. Cl. A61C 3/00

(52) U.S. Cl. 433/4; 433/20

(57) ABSTRACT

A crimping machine includes a platform having a substantially flat upper working surface and a first crimping jaw fixed on the platform. An arm is slidably attached to the platform, the arm having a second crimping jaw provided thereon, the arm being slidable at least between a first, crimping position in which the first and second jaws are opposed and adjacent one another and spaced apart by a first distance sufficient to crimp a workpiece between the first and second jaws, and a second, open position in which the first and second jaws are opposed and spaced apart by a second distance, the second distance being greater than the first distance and sufficient to insert an uncrimped workpiece therebetween. A resilient biasing element is provided for biasing the second jaw towards the first jaw. An actuator is provided for forcing the arm into the first, crimping position.

### BACKGROUND OF THE INVENTION

It is known to provide crimpable tubes on archwires to function as, e.g., stops and to provide crimpable posts and/or hooks. A hand tool, i.e., crimping pliers for crimping tubes onto archwires is described in applicant's U.S. patent application Ser. No. 12/114,924, filed May 5, 2008. The pliers are very useful for crimping a limited number of tubes, e.g., by an orthodontist while the archwire is in the patient's mouth or shortly before.

It is also known to manufacture an orthodontic archwire including a curved anterior segment and a pair of posterior segments connected to and extending from respective ends of the curved anterior segment. The curved anterior segment and the pair of posterior segments comprise three discrete pieces joined together to form the generally parabolic shape. The three discrete pieces joined together by crimping tubes over respective butted or overlapped ends of adjacent pieces. See, applicant's U.S. Pat. No. 6,811,397, issued Nov. 2, 2004, the contents of which are incorporated herein by reference in their entireties.

Applicant has found the need for a crimping machine that is both simple in design, inexpensive to manufacture and can efficiently crimp tubes onto archwires or crimp tubes to join archwire segments.

### BRIEF SUMMARY OF THE INVENTION

A crimping machine includes a platform having a substantially flat upper working surface and a first crimping jaw fixed on the platform. An arm is slidably attached to the platform, the arm having a second crimping jaw provided thereon, the arm being slidable at least between a first, crimping position in which the first and second jaws are opposed and adjacent one another and spaced apart by a first distance sufficient to crimp a workpiece between the first and second jaws, and a second, open position in which the first and second jaws are opposed and spaced apart by a second distance, the second distance being greater than the first distance and sufficient to insert an uncrimped workpiece therebetween. A resilient biasing element is provided for biasing the second jaw towards the first jaw. An actuator is provided for forcing the arm into the first, crimping position.

A method for crimping a tube on an archwire using such a crimping machine includes sliding the arm against the bias of the resilient biasing element into the second, open position in which the first and second jaws are opposed and spaced apart by the second distance, inserting an archwire having an uncrimped tube surrounding a portion of the archwire between the first and second jaws, and actuating the actuator to force the arm into the first, crimping position to crimp the tube onto the portion of the archwire.

A method for joining a plurality of archwire segments using such a crimping machine includes sliding the arm against the bias of the resilient biasing element into the second, open position in which the first and second jaws are opposed and spaced apart by the second distance, inserting archwire segments having an uncrimped tube surrounding portions of respective, adjacent ends of the archwire segments between the first and second jaws, and actuating the actuator to force the arm into the first, crimping position to crimp the tube onto respective, adjacent ends of the archwire segments to thereby join the archwire segments.

### BRIEF DESCRIPTION OF THE SEVERAL VIEWS OF DRAWINGS

FIG. 1 is a plan view of the crimping machine of the present invention;

FIG. 2A is a side elevational view of the crimping machine with the crimping jaws closed;

FIG. 2A is a side elevational view of the crimping machine with the crimping jaws in an open position;

FIG. 3A is a plan view of an element having a first crimping jaw;

FIG. 3B is an enlarged breakaway plan view of a portion of the element having a first crimping jaw, showing the first crimping jaw in detail;

FIG. 4A is a side elevational view of an arm having a second crimping jaw;

FIG. 4B is an enlarged breakaway plan view of a portion of the arm having a second crimping jaw, showing the second crimping jaw in detail; and

FIG. 5 is a breakaway schematic view showing a portion of the crimping machine during a step in the method for crimping a tube on a portion of two archwire segments to join the segments.

### DETAILED DESCRIPTION OF THE INVENTION

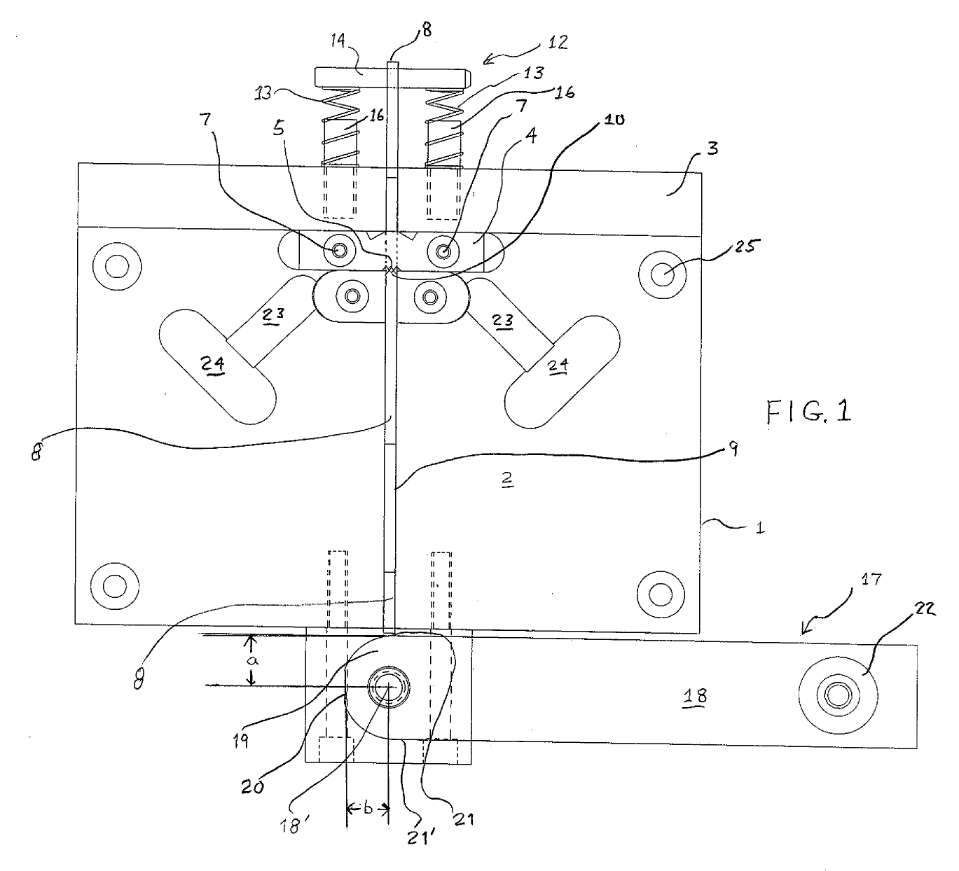

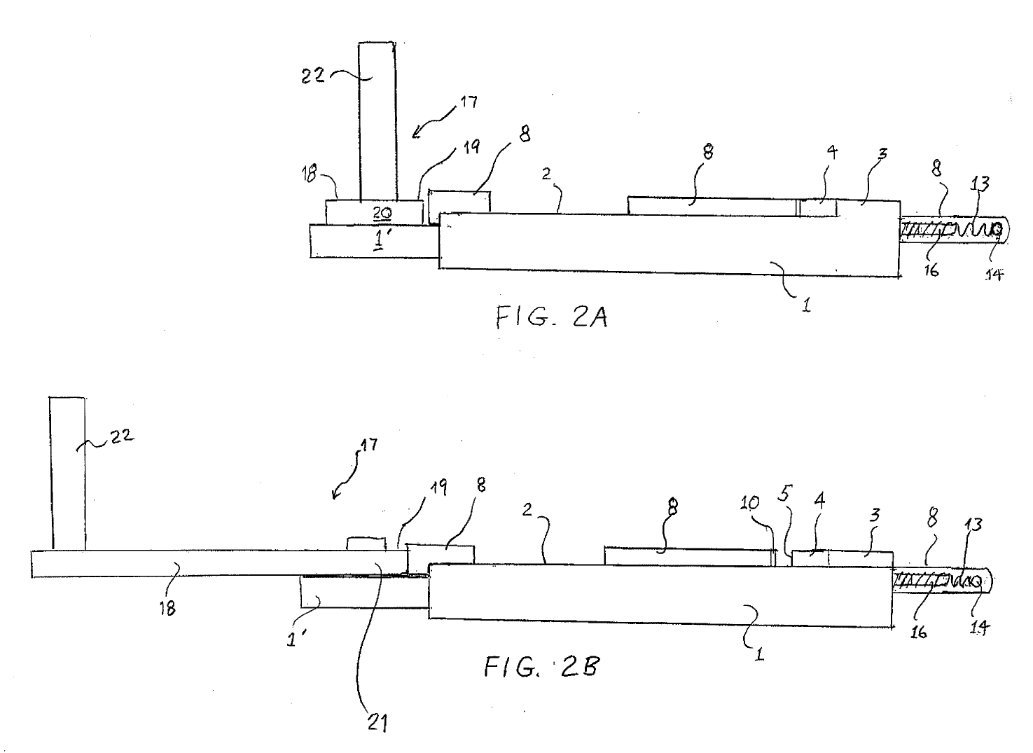

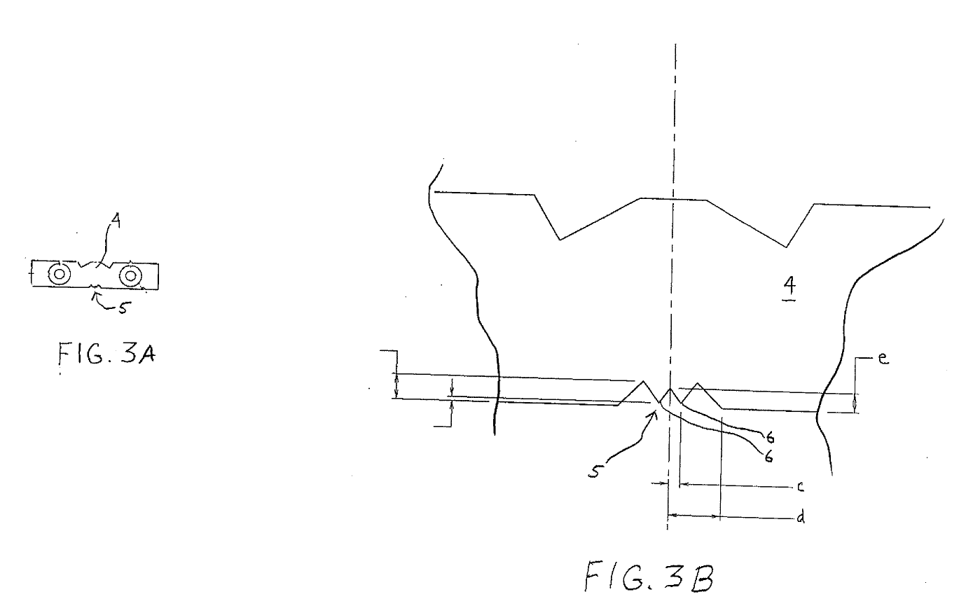

The crimping machine of the present invention is generally shown in plan view in FIG. 1 and in side elevational view in FIGS. 2A and 2B, which show the crimping machine in use in two different operating positions. In the embodiment of the present invention shown in the figures, the crimping machine includes a platform 1 having substantially flat upper working surface 2. The platform 1 has a raised portion 3 acting, in this embodiment, as a stop to assist in the crimping operation, as will be apparent from the description hereinafter. As shown in FIGS. 1, 2A and 2B, a member 4 having a first crimping jaw 5 is fixed to the platform 1, e.g., by screws 7. As more clearly shown in FIGS. 3A and 3B, the first crimping jaw 5 has a plurality, in this example two, crimping points 6, 6 spaced by a distance (referring to FIG. 3B) of 2c. The depth of the crimping points 6, 6 has a distance e and the opening in the member 4 for the first crimping jaw 5 has a length 2d (also referring to FIG. 3B). In a specific embodiment of the crimping machine useful for crimping a tube to join two segments of an archwire, as will be explained more fully hereinafter, the distances c, d, and e are 0.02 inches, 0.094 inches and 0.034 inches, respectively, although clearly these distances can be changed for different types and sizes of workpieces, as would be understood by those skilled in the art. While, in this embodiment, the first crimping jaw 5 is provided on a member 4 that is made separate from and then fixed to the platform 1, it will be understood that the first crimping jaw 5 can be fixed to the platform 1 by being made integral therewith.

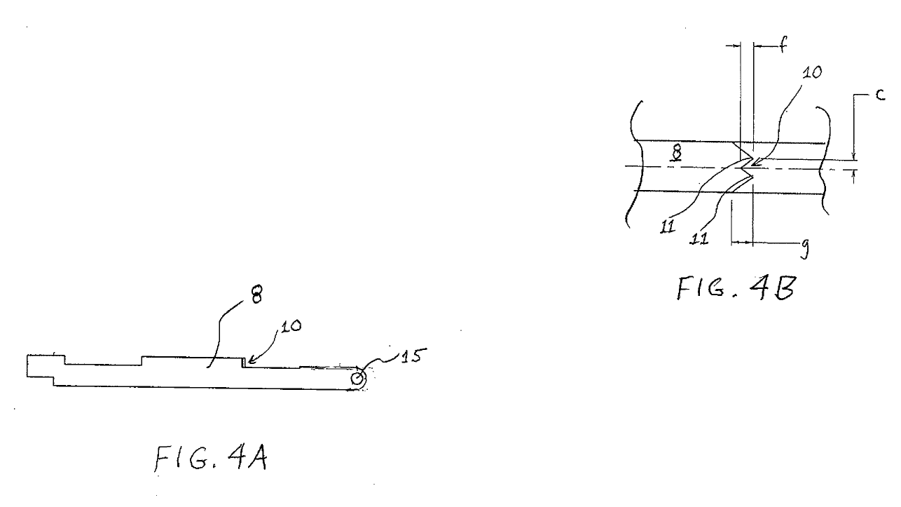

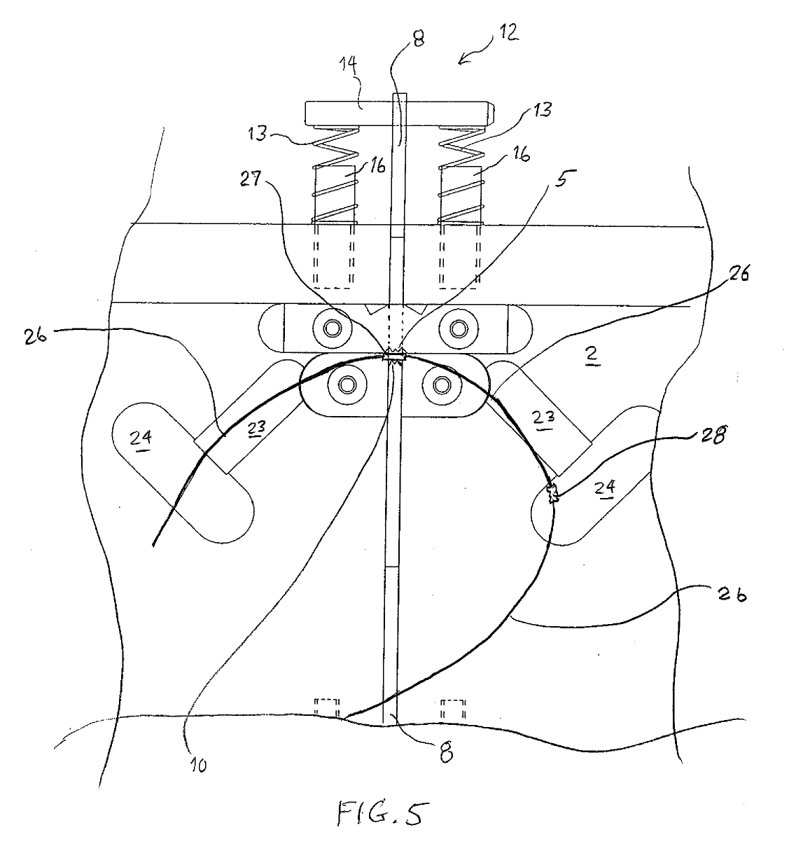

As generally shown in FIGS. 1, 2A and 2B, an arm 8 is slidably attached to the platform 1 and slides in groove 9 provided in the flat upper working surface 2 of the platform 1. The arm 8 is longer than the length of the platform 1 so that the ends of the arm 8 extend beyond the ends of the platform 1, as shown in FIGS. 1, 2A and 2B. One example of the shape of the arm 8 is shown in side elevational view in FIG. 4A. As can be appreciated from FIGS. 1, 2A, 2B and 4A, the arm 8 has a shape such that portions of it are raised above the upper working surface 2 of the platform 1 while portions of it are even with the upper working surface 2 or even therebelow so as to enable the arm 8 to, e.g., pass beneath the member 4 or to provide a flat working surface (as it will be more apparent with reference to FIG. 5). The arm 8 has a second crimping jaw 10 provided thereon. As best shown in FIG. 4B, the second crimping jaw 10 can also have a plurality of crimping points 11, 11, two this embodiment, preferably corresponding to the crimping points 6, 6 on the first crimping jaw 5. Thus, as shown in FIG. 4B, the crimping points 11, 11 are also spaced by a distance 2c. In this embodiment, the total depth of the crimping points 11, 11 is shown in FIG. 4B with a distance g, while the depth of the space between the crimping points 11, 11 is shown with a distance f. In one specific embodiment useful for joining segments of archwires with a crimping tube (described hereinafter) the distances have f and g may be 0.027 inches and 0.045 inches, respectively. Of course, other distances can be chosen depending on the type and size of the workpiece.

The arm 8 is slidable at least between a first, crimping position in which the first and second jaws, 5, 10, are opposed and adjacent one another and spaced apart by a first distance sufficient to crimp a workpiece therebetween, and a second, open position (see, e.g., FIG. 2B) in which the first and second jaws 5, 10 are opposed and spaced apart by a second distance, the second distance being greater than the first distance and sufficient to insert an uncrimped workpiece therebetween.

A resilient biasing element 12 is provided for biasing the second jaw 10 towards the first jaw 5. In the embodiment shown in the figures, the resilient biasing element 12 comprises biases springs 13 which press against a dial 14 held within opening 15 in arm 8 (see FIG. 4A). The biasing springs 13 are retained on the platform 1 by being provided over posts 16, 16. Thus, bias springs 13, 13 push on dowel 14 urging arm 8 to slide into a position which, in this embodiment, the crimping points 6, 6 of first crimping jaw 5 and crimping points 11, 11 of second crimping jaw 10 are in contact with one another. This position is shown in side elevational view of FIG. 2A.

To use the crimping machine of this embodiment, a workpiece can be inserted by first pushing on the dowel 14 or the end of the lever 8 to which the dowel 14 is attached towards the platform 1, as shown in FIG. 2B. This slides the arm 8 into an open position in which the first and second jaws 5, 10 are opposed and spaced apart by a distance sufficient to insert an uncrimped workpiece therebetween.

As shown in FIGS. 1, 2A and 2B, an actuator 17 is provided for forcing the arm 8 into the first, crimping position. In this embodiment, the actuator 17 is a lever 18 rotatable about a rotation axis 18′ perpendicular to the substantially flat upper working surface 2 of the platform 1. The lever 18 has a cam element 19 on an end thereof and interacts with the arm 8 for forcing the arm into the first, crimping position. As shown in FIG. 1, the cam element 19 is made such that the distance a between the rotation axis 18′ and the side edge 21 of the lever 18 is greater than the distance b between the rotation axis 18 and the end 20 of the lever 18. In this manner, when the end 20 of the lever 18 is adjacent the end of the arm 8, i.e., the position shown in FIG. 2B, the arm 8 can be slid against the end 20 of the lever 18 by pushing on the dowel 14 or the end of the lever 8 to which the dowel 14 is connected so as to provide a sufficient distance between the first and second clamping jaws 5,10 to insert a workpiece therebetween. With a workpiece between the crimping jaws 5, 10, e.g., a tube provided around a portion of an archwire, the lever 18 can be turned using handle 22 from the position shown in FIG. 2B to the position shown in FIGS. 1 and 2A, which motion causes the side 21 of the lever 18 to be forced against the end of the arm 8, sliding the arm 8 such that the second clamping jaw 10 is slid towards the first clamping jaw 5 to crimp the workpiece therebetween.

The upper surface 2 of the platform 1 can have one or more indentations, e.g., 23, 24, to assist a user in grasping a workpiece laying on the working surface 2. One or more through holes 25 can be provided to attach the platform 1 to a fixed surface.

FIG. 5 shows one step of a method of using the crimping machine of the present invention to crimp a tube over a portion over an archwire. In the embodiment shown in FIG. 5, after the arm 8 is moved into the open position (see FIG. 2B), an archwire 26 can be provided onto the working surface 2 of the platform. In this embodiment, a crimping tube 27 is provided over a portion of the archwire 26. The crimping tube 27 may be one which is provided to function, e.g., as a stop or to include a crimpable post or hook, or can be one which is used to join discrete pieces or segments of the archwire to form an archwire of the type described in Applicant's U.S. Pat. No. 6,811,397. With the crimping tube 27 and archwire 26 provided between the clamping jaws 5, 10, as shown in FIG. 5, the actuator 17 is moved from the position shown in FIG. 2B to the position shown in the position shown in FIGS. 1 and 2A to force the crimping jaw 10 towards the crimping jaw 5 to crimp the tube 27 onto the archwire 26. FIG. 5 shows an already crimped tube 28 also provided on the archwire 26.

Thus, the crimping machine of the present invention can be used to crimp a tube on an archwire by sliding the arm 8 against the bias of the resilient biasing element 12 to the second, open position, as shown in FIG. 2B. In such open position, an archwire 26 having an uncrimped tube surrounding a portion of the archwire 26 is inserted between the first and second jaws 5, 10. The actuator 17 has been actuated to force the arm 8 into the first, crimping position to crimp the tube 27 onto the portion of the archwire 26.

The crimping machine can also be used for joining a plurality of archwire segments by sliding the arm 8 against the bias of the resilient biasing element 12 into the second, open position shown in FIG. 2B. Two archwire segments 26, 26 having an uncrimped tube 27 surrounding portions of respective, adjacent ends of the archwire segments 26, 26 are provided between the first and second jaws 5, 10. The actuator 17 is then actuated to force the arm 8 into the first, crimping position to crimp the tube 27 onto respected, adjacent ends of the archwire segments 26, 26 to thereby join the archwire segments.

Of course, the crimping machine is useful for crimping other workpieces as would be apparent to those skilled in the art.

Those skilled in the art will understand that many modifications and variations of the present invention are possible in light of the above teachings. It is therefore to be understood that, within the scope of the appended claims, the invention may be practiced otherwise than as specifically shown and described. Therefore, while the accompanying figures show and this description describes some embodiments of the invention, the invention is not limited thereto. One skilled in the art will understand that numerous variations and modifications are possible without departing from the spirit and scope of the invention defined by the following claims.

I Claim:

1. A crimping machine, comprising:
a platform having a substantially flat upper working surface;
a first crimping jaw fixed on the platform;
an arm slidably attached to the platform, the arm having a second crimping jaw provided thereon, the arm being slidable at least between a first, crimping position in which the first and second jaws are opposed and adjacent one another and spaced apart by a first distance sufficient to crimp a workpiece between the first and second jaws, and a second, open position in which the first and second jaws are opposed and spaced apart by a second distance, the second distance being greater than the first distance and sufficient to insert an uncrimped workpiece therebetween;
a resilient biasing element for biasing the second jaw towards the first jaw; and
an actuator for forcing the arm into the first, crimping position.

2. The crimping machine according to claim 1, wherein the arm has a third position in which the first and second jaws are opposed and in contact, and the resilient biasing element biases the arm into the third position in which the first and second jaws are in contact.

3. The crimping machine according to claim 1, wherein each of the first and second crimping jaws has a plurality of spaced crimping points, the crimping points of the first crimping jaw being aligned with the crimping points of the second crimping jaw.

4. The crimping machine according to claim 1, wherein the actuator is a lever rotatable about a rotation axis perpendicular to the substantially flat upper working surface of the platform, the lever having a cam element on an end thereof and interacting with the arm for forcing the arm into the first, crimping position.

5. The crimping machine according to claim 1, wherein the substantially flat upper working surface of the platform has at least one indentation to assist a user in grasping a workpiece laying on the working surface.

6. A method for crimping a tube on an archwire using the crimping machine of claim 1, comprising:
sliding the arm against the bias of the resilient biasing element into the second, open position in which the first and second jaws are opposed and spaced apart by the second distance;
inserting an archwire having an uncrimped tube surrounding a portion of the archwire between the first and second jaws; and
actuating the actuator to force the arm into the first, crimping position to crimp the tube onto the portion of the archwire.

7. A method for joining a plurality of archwire segments using the crimping machine of claim 1, comprising:
sliding the arm against the bias of the resilient biasing element into the second, open position in which the first and second jaws are opposed and spaced apart by the second distance;
inserting archwire segments having an uncrimped tube surrounding portions of respective, adjacent ends of the archwire segments between the first and second jaws; and
actuating the actuator to force the arm into the first, crimping position to crimp the tube onto respective, adjacent ends of the archwire segments to thereby join the archwire segments.
